(19) United States
(12) Patent Application Publication
(10) Pub. No.: US 2015/0235244 A1
(43) Pub. Date: Aug. 20, 2015

(54) SURVEY METHOD AND SYSTEM

(71) Applicant: Jason Anderson, Kansas City, MO (US)

(72) Inventor: Jason Anderson, Kansas City, MO (US)

(21) Appl. No.: 14/625,118

(22) Filed: Feb. 18, 2015

Related U.S. Application Data
(60) Provisional application No. 61/941,265, filed on Feb. 18, 2014.

(51) Int. Cl. G06Q 30/02

(52) U.S. Cl. CPC G06Q 30/0203

(57) ABSTRACT

A method and system to incentify a user to participate in a survey providing accurate, reliable and complete answers with tools to a researcher to create a research project and research games. The research game is published online where users play the research game. The system measures in-game answers, selections, behaviors and outcomes. The system analyzes these in-game responses and reports the game behaviors and outcomes to the research client. Information regarding the research project, research game, the research client, the user, responses and reports are stored in one or more databases.

### CROSS REFERENCE TO RELATED APPLICATION

This application claims the benefit of co-pending provisional application Ser. No. 61/941,265, filed Feb. 18, 2014, entitled “Survey Method and System.”

### FIELD

The present invention relates to surveying systems to determine user preferences and, more particularly, to a surveying method and system using games to incentify user participation and more complete results.

### BACKGROUND

Online surveys are known. Services such as Survey Monkey, Survey Gizmo, Constant Contact and Survata, for example, provide templates to build an online survey. Users are invited via email to click on an included link to participate in the survey. A problem with these surveys is that the user often has no incentive to respond accurately, truthfully or to complete the survey. If there is an incentive to complete the survey, such as a gift certificate, the user often hurries through the survey to get the reward without regard to the answers provided. The result is often that the data collected is incomplete or not reliable. There is a need for a survey method that naturally incentifies a user to provide accurate and complete information for any given survey.

### SUMMARY

The present invention provides a method and system to incentify a user to participate in a survey providing accurate, reliable and complete answers.

The method and system provides tools to a researcher to create a research project and research games. The research game is published online where users play the research game. The system measures in-game answers, selections, behaviors and outcomes. The system analyzes these in-game responses and reports the game behaviors and outcomes to the research client. Information regarding the research project, research game, the research client, the user, responses and reports are stored in one or more databases.

### BRIEF DESCRIPTION OF THE DRAWINGS

FIG. 1 is an overview of the method of the present invention.

FIG. 2 is a list of system databases utilized by the research process.

FIG. 3 is a relational diagram of the research client interface to the research method.

FIG. 4 is a flow chart illustrating creation of a research project.

FIG. 5 is a flow chart illustrating publication of the survey.

FIG. 6 is a flow chart illustrating operation of a research game.

FIG. 7 is a flow chart illustrating the process to analyze and report the data to the research client.

### DETAILED DESCRIPTION

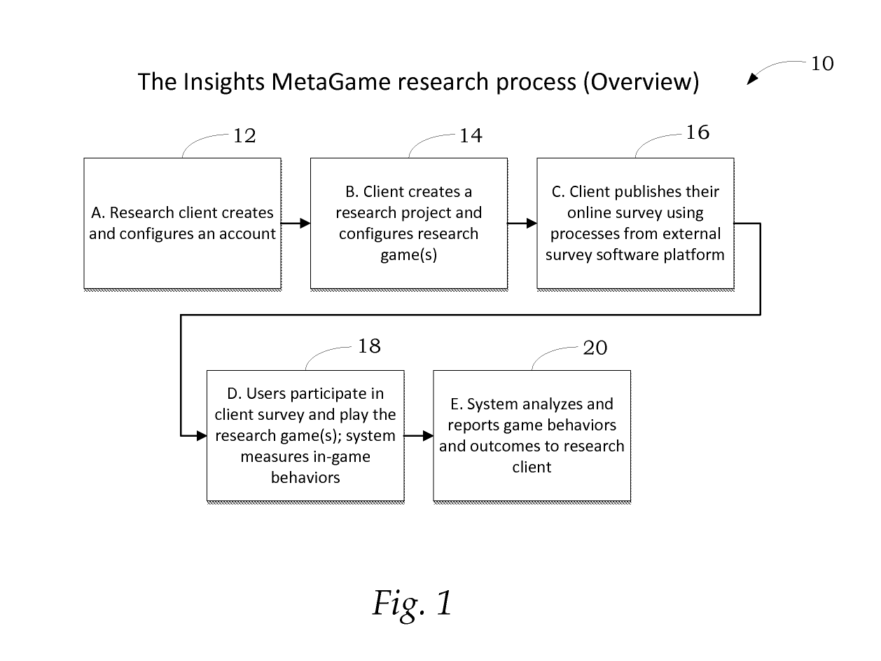

Referring initially to FIG. 1, the research process is generally identified by reference numeral 10. Research process 10 generally includes five overall steps, although fewer or more steps may be utilized or desired. The research process 10 begins with the research client creating and configuring an account 12. The client creates a research project and configures one or more research game(s) 14. The client publishes an online survey using processes from an external surveying software platform 16. Users participate in the survey and play the research game(s), with the inputs and behaviors captured by the system 18. The process then analyzes and reports game behaviors and outcomes to the research client 20.

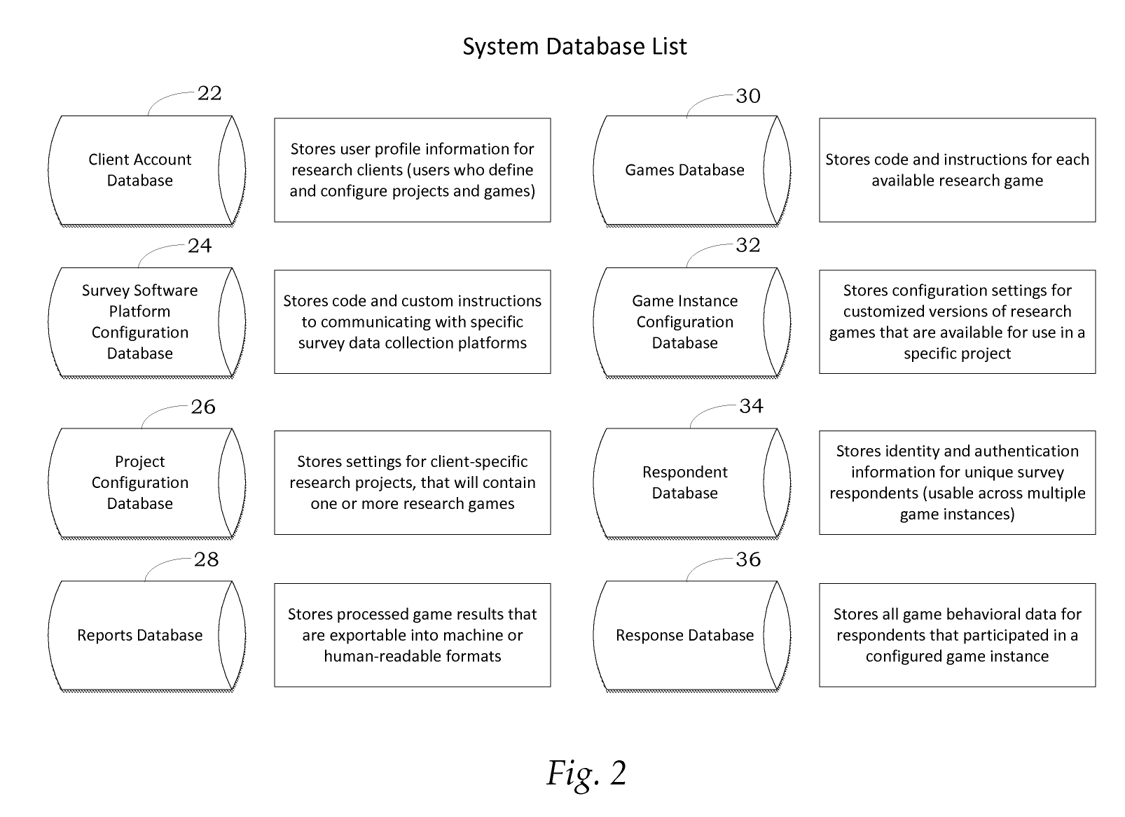

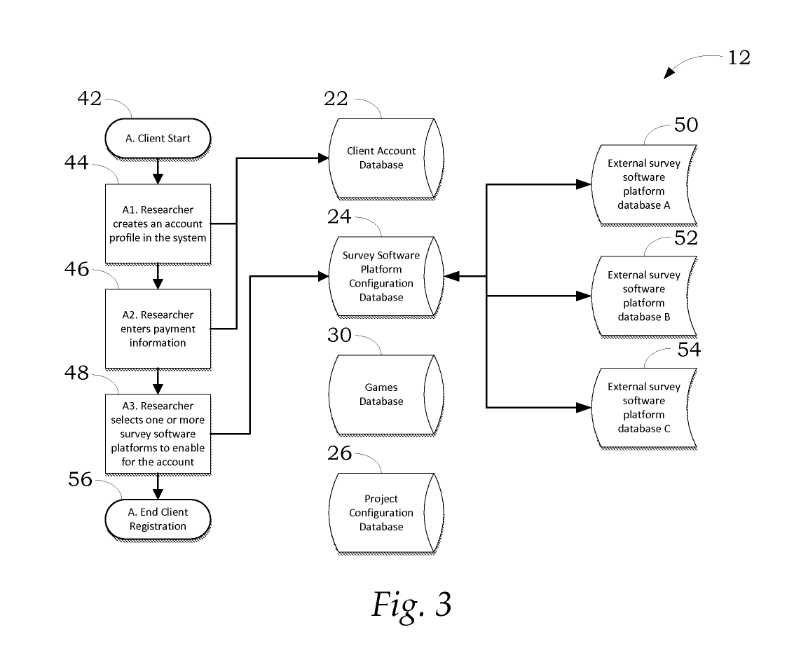

Referring to FIGS. 1-3, further details of the client registration process 12 are illustrated in FIG. 3. New clients first register for an account on the research project host service 42. The researcher creates an account 44. Account registration process captures contact information, number and identity of authorized users, and desired service plan level, which is stored in a client account database 22. Payment information is captured from the client 46 (either credit card for monthly billing, or a purchase/service order for verification, for example), which is stored in the client account database 22. After the payment information is verified, the client account record in the database 22 is updated to indicate which games are authorized for production use. The research client then selects one or more survey software platforms, which will be used for integration and game publishing 48 from a list of available survey software platforms. The selection is stored in a Survey Software Platform Configuration Database 24 in conjunction with the available games stored in the Games Database 30 and the Project Configuration Database 26, which stores settings for client-specific research projects containing one or more games. Each record in the Survey Software Platform Configuration Database 24 contains the necessary code to manage publishing of games into an external system, launching new instances of games within that platform, storing game results into that platform's data warehouse, and transferring user focus back to the survey platform when exiting the game. A survey software platform may be an external survey data collection service 50, 52, and 54, such as SurveyGizmo, Decipher, or Qualtrics, for example. If the client wishes to use a survey platform that has not been integrated into the service, they may select “Browser Redirect” which will redirect the survey respondent from the client's system to internal servers to launch the game. The survey respondent will then be redirected back to an external website when the game is finished. This allows for full compatibility with all survey platforms. Once the client information is configured for the particular research client, the registration process terminates 56.

For example, to create a new account, a research client may submit an email address for a username, first and last name, and desired password the service website. The research client may select from one or more licensing and pricing models before using the service. For example, a trial access account may provide access to a subset of the game catalog, for up to 100 respondents per game per month for one project at no charge. One project may be active at any time, with one game per project. As another example, a basic access account may include up to 500 respondents per month at a set charge per month with additional respondents over 500 charged at set rate per complete. Up to two projects may be active at any time, with one game per project. As a further example, a professional subscription account may include up to 1,000 respondents per month at a set charge per month. Additional respondents may be charged at a set rate per complete. An unlimited number of projects and games may be active at any time. This account level may also enable additional visual customizations for some of the games. As an additional example, an enterprise account type may only available for longer term subscription periods, with pricing based on annual response volumes.

The account's licensing method and payment information is stored in the client account database 22. The system verifies payment information such as the account credentials via a third party payment gateway provider for credit card payments, or a voice confirmation may be obtained from the accounts payable point of contact at the client organization for a purchase order payment.

Integration with Data Collection Platform(s)

Before a client can publish a research game, the client must link their service account to an external data collection platform (e.g., SurveyGizmo, Decipher Beacon). This linking process may vary depending on the data collection platform. For example, using SurveyGizmo for illustrative purposes:

1. Client logs in to their SurveyGizmo account.

2. In the Account Settings menu, they navigate to Plug-Ins.

3. If not already enabled, the client activates their third party API key.

4. The client pastes the API key into the Insights Meta configuration page.

5. The system tests the connection to verify it is able to exchange data with the system.

6. The integration link process is repeated for as many third party data collection platforms as desired. (NOTE: it is not mandatory to link to an external system, the games can operate in a stand-alone configuration.)

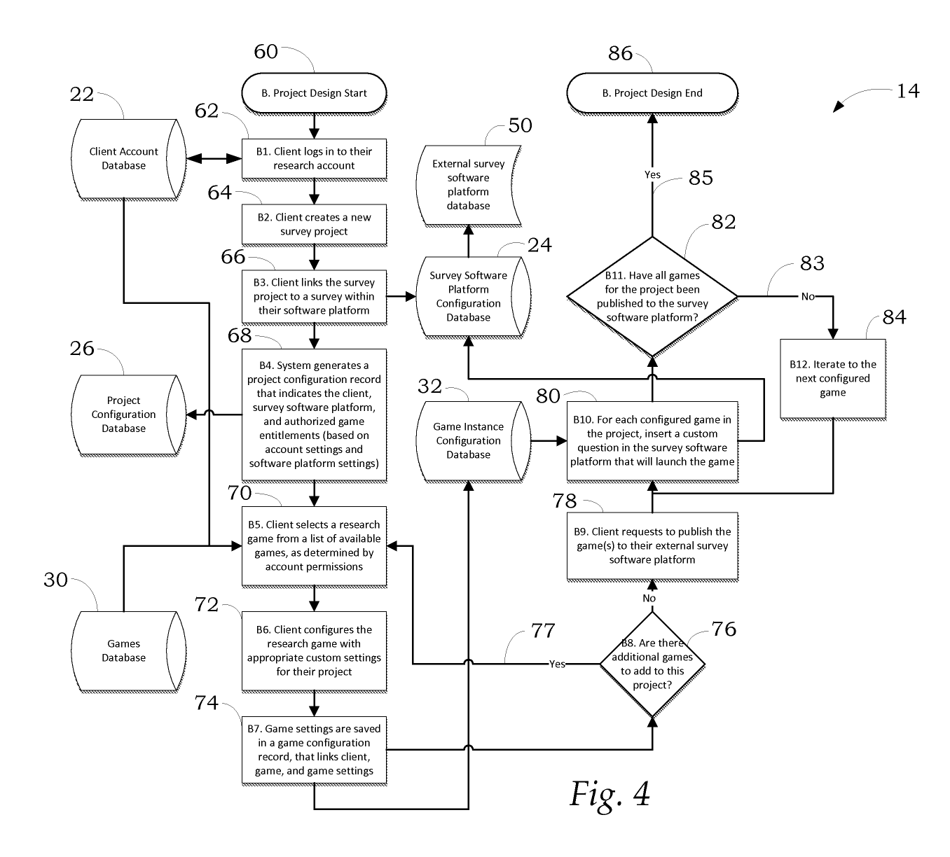

Referring to FIGS. 1, 2 and 4, further details of the project design process 14 are illustrated in FIG. 4. A client begins a new game-enabled survey project 60 by logging into their account 62 accessing the Client Account Database 22. The research client creates a new survey project 64 and links the new project to one of the survey software platforms configured in their account 66. The platform information is retrieved from the Survey Software Platform Configuration Database 24. The survey project list is provided to the system directly by the external survey software platform database 50 via a published API.

A project configuration record is generated and stored 68 in the project configuration database 26, which links the client, software platform, survey identifier, and authorized game entitlements based on account settings and any compatibility constraints indicated by the platform configuration database. The client selects a game from the list of available research games 70 from the Games Database 30. Next, the client defines custom configuration settings for the game, such as product names, art styles, or other configurable attributes 72. The list of configurable attributes is unique to each game and are stored in the games database 30.

The client's unique game configuration is saved 74 in a Game Instance Configuration Database 32, which represents a unique configuration for a specific game. The Game Instance Configuration Database 32 is used to launch a unique instance of a game for each survey user.

The client may optionally configure multiple games for their project 76, by adding additional games 77 and publish all of them within the same research survey. The client then requests that the configured games to be published into their survey platform 78. Once published, configurations may be locked and may not be changed (though they may be replaced). For each configured game in the project, a custom question is inserted in the survey software to launch the game 80. The Software Platform Configuration Database 24 provides custom code for the selected platform that will insert the configured game into a research survey. A check is made for additional games to be published 82. If additional games for the project need to be published 83, the publishing process is repeated for all configured games 84. If all games have been published 85, the survey is now ready and the design process ends 86.

By way of example, to create a project, the client may select to create a new project from the project management screen. The client provides a descriptive name for the project, selects any data collection integrated platforms that may be used with this project, and saves the new project. The system creates a new project record that stores the project title, creation date, owner, status, and integration platforms to be used, for example, in the project configuration database 26.

The project starts in a design state by default and the client is redirected to the project management screen to configure one or more games. From the project management screen, the client may choose to add a game. The system retrieves the access permissions for the client account database 22 to determine which game(s) are authorized for usage by the client. The system retrieves the list of authorized games, their genre, and their research scenario from the games database 30. A genre may be a type of gameplay experience, such as word search, card game, board game, number puzzle, simulator, etc., for example. A scenario may be the research objective being addressed by the game, such as brand awareness, demographic profiling, MaxDiff model, pricing, customer satisfaction, etc., for example.

The client selects the desired game to be added to the project. By way of example, a MaxDiff card game will be described, not as limiting, but for illustrative purposes. Other genres and research scenarios may have different but similar use cases.

The client selects which data collection platform is to be used for this game. The client enters the game configuration screen for the game (for example, MaxDiff card game). The user creates a new attribute to be tested by entering a text description of the attribute, or uploading an image to be used to represent the attribute, or both, for example. The user continues creating new attributes until all attributes have been created. The user may edit and delete attributes. The user may customize the background artwork for the game and/or the image for the back of the cards if desired.

The client saves the game configuration settings a record in a Gamelnstance configuration database 32. The record may include a unique instance identifier, the data collection platform to be used, the game type, the custom game settings, and the project ID, for example.

The client may continue creating and configuring games for the project until reaching the limits for their level of account (e.g., trial and basic accounts may only have one game per project, while professional and enterprise accounts have no such limitation).

The client may play a test version of their game by selecting “Test” from the game configuration screen. The system retrieves the Gamelnstance identifier for the game being tested and the game code for the selected game type. The system displays a game testing page and dynamically inserts into the HTML code the HTML and JavaScript code for the retrieved game type, the Gamelnstance identifier for the game configuration, and the client authentication ID.

The game code (which may be running locally on the client's browser) may request game configuration settings from the system's server, using the GameInstance and authentication identifiers. The system verifies the valid GameInstance identifier matches the authentication ID, and that the authenticated user is linked to the GameInstance. The system checks the status of the project associated with the Gamelnstance, and determines that it is in a design state. Because the game is not in a live state, no data will be saved and there are no response quotas to check. The system retrieves the Gamelnstance settings and responds to the client's JavaScript request with the configuration data. The local game proceeds, using the retrieved configuration settings.

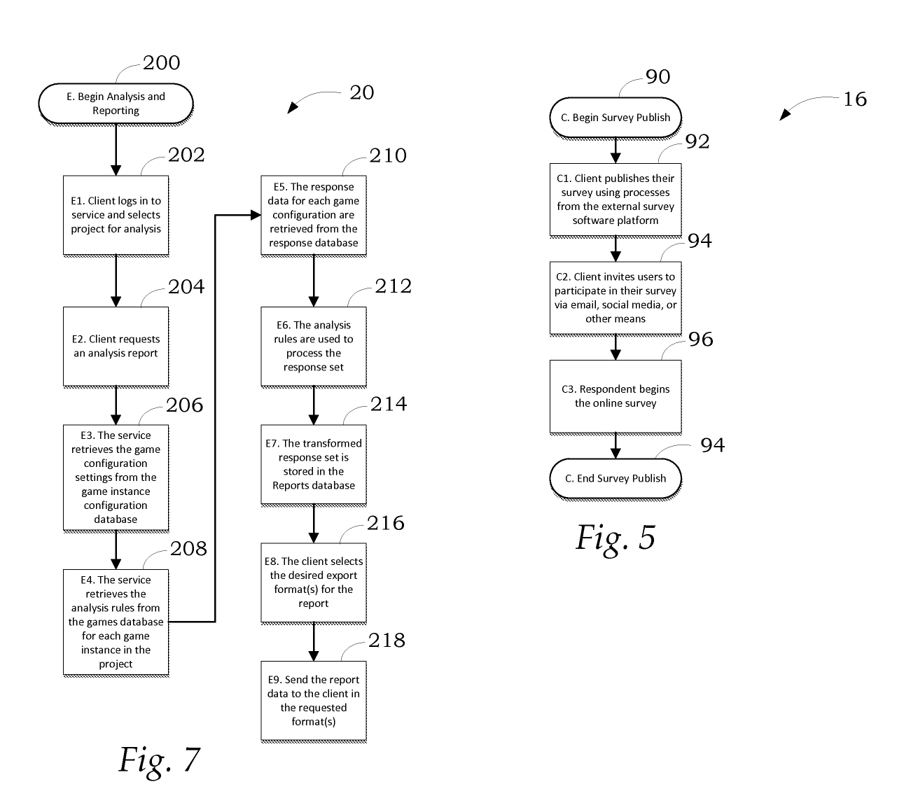

Referring to FIGS. 1 and 5, further details of the publication process 16 are illustrated. The process to publish the client survey begins 90 with the client using processes from the external survey software platform API's to publish the survey 92. Users are invited to participate in the survey via email, social media or other means 94. Once a user respondent begins the online survey 96, the survey publication is complete 98.

By way of example, when the client has fully configured the project and all games within the project, the client selects to publish the game from the project management page. The system retrieves the current client account status (subscription level, number of completed responses this month) and calculates how many responses are currently available within the prepaid subscription. A summary of the project and account information may displayed, including the project title, the game(s) configured for the project, the number of responses available without additional charge, and the cost per additional response above the available balance, for example.

The client may enter a maximum number of responses to collect for each game, or indicates that there is no maximum. The client selects publish. The exact publishing process may vary depending on the data collection platform. The following description covers an illustrative scenario with SurveyGizmo.

The service retrieves the SurveyGizmo “bootstrap” code. The bootstrap code is a generic XML file that conforms to the data structure of SurveyGizmo's developer API. The service copies the bootstrap XML code and inserts the game's CSS code and GameInstance parameters. The bootstrap code may use the GameInstance parameters to connect to the service and retrieve the game's HTML and JavaScript code. The GameInstance record is updated with the customized XML file.

Next, the service prompts the user to download the XML file and provides instructions on how to install the custom question in the user's SurveyGizmo account. The user logs in to SurveyGizmo and navigates to the developer's corner. The user uploads the XML file and saves the new question type. The user may add a custom question to the survey's design on the desired page within the survey. This process is repeated for all games being added to the survey.

The project is then set to a test state and the client is notified that the project is now publishable and can be tested within the external survey system. The client conducts normal testing on their externally programmed survey. When reaching the custom question type within the survey, the bootstrap code will retrieve necessary game code from the service and present it within the survey framework.

If the client wants to make any changes to the game configuration, the client removes the old game from their external survey platform, returns to the game configuration instructions and repeats the test/publish cycle. When the client is satisfied with the survey and the game configuration, they activate the game from the service's project management page by selecting “Go Live”.

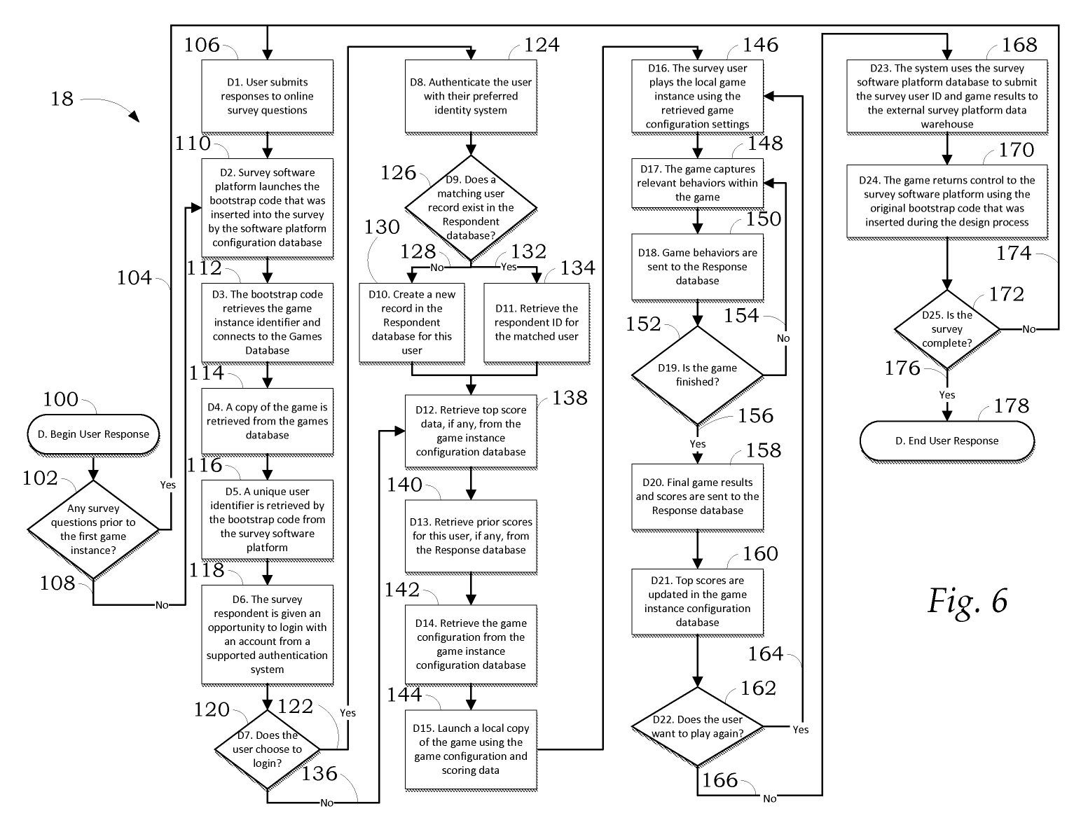

Referring to FIGS. 1, 2 and 6, further details of the research game operation 18 are illustrated. The user begins the online survey 100 and may be presented with one or more initial survey questions before the first GameInstance 102. If presented with at least one survey question 104, the user provides responses to the questions 106. If not provided with an initial survey question 108, bootstrap code inserted into the survey by the survey software platform configuration database 24 is launched 110, which retrieves the GameInstance identifier 112 and connects to the Games Database 30. A copy of the game is retrieved 114 from the Games Database 30. A unique user identifier is retrieved by the bootstrap code 116 from the survey software platform configuration database 24. The survey respondent is presented with a login script 118 with an option to login with an account from a supported authentication system 120, such as an email account or social media account. If the user chooses to login 122, the user name and password is provided to the authentication system 124. The authentication system receives the information to authenticate the user information 126. If the user information does not exist 128 in the Respondent Database 34, a new record is created in the Respondent Database 34 for this user 130. If the user information exists 132 in the Respondent Database 34, the respondent ID is retrieved for the matched user 134.

If the user chose to not login 136, processing continues at block 138. Previous top scores, if any, are retrieved 138 from the Game Instance Configuration Database 32. For matched users, previous top scores are retrieved 140, if any, from the Response Database 36. Next, the game configuration is retrieved 142 from the Game Instance Configuration Database 32 and a local copy of the game is launched using the game configuration and scoring data 144. The survey user plays the local GameInstance using the retrieved game configuration settings 146. The game captures relevant behaviors during the game 148 and stores them 150 in the Response Database 36. The end of the game is checked 152 and if not the end 154, the game continues 148. If the game is over 156, the final game results and scores are sent 158 to the Response Database 36. The top scores are updated 160 in the Game Instance Configuration Database 32 if necessary. The user may then be given an opportunity to play the game again 162. If the user decides to play the game again 164, the game restarts 146. If the user decides to not play the game again 166, the system uses the survey software platform database 24 submits the survey user ID and game results to an external survey platform data warehouse 168. The control of the game is returned to the survey software platform using the original bootstrap software 170. The progress of the survey is then determined 172. If the survey is not complete 174, the user is provided with additional survey questions 106. If the survey is completed 176, the process is terminated 178.

By way of example, data collection and gameplay begins when the client launches their survey using the third party data collection provider's processes and tools. Participants are directed to the entry point for the survey on the third party data collection platform. The participants answer survey questions using existing interfaces from the data collection platform. On reaching a custom game question type, the bootstrap code that was inserted into the data collection platform is executed. The bootstrap code sends the GameInstance identifier, project identifier, and authentication token to the game service.

The game service then attempts to retrieve the matching GameInstance record. If a matching GameInstance record was found, the service compares the submitted project ID and authentication token with the project ID an authentication token contained in the GameInstance record. If the GameInstance record is successfully validated, the service retrieves the status of the project and any quotas set for completed responses.

If the GameInstance record was authenticated, the project is live, the number of responses authorized for the game is under the quota maximum, and the client account status is live, then the service continues with the game startup process. Otherwise, it returns a NULL value and the bootstrap code automatically skips the game question and proceeds to the next item in the survey.

The service retrieves the game type and game configuration settings for the GameInstance. The service injects the game configuration settings into the game code as a text replacement. The service responds to the survey platform with the customized game code that contains the game configuration settings. The bootstrap code executes a GameInitialization ( ) function, which has been dynamically inserted into the question's HTML page.

For example, using the MaxDiff Card Game Rules for illustrative purposes only and not as limiting, the game creates a deck of cards that contains four copies of each attribute in the game configuration attribute list. A score of zero (0) is assigned to each attribute. A game board is displayed with a play area containing four card slots and a match area containing up to three card slots. The initial game board is empty. The game shuffles the deck of cards. The shuffled deck of cards is displayed face-down in a draw pile.

The player clicks the draw pile to draw one card for each empty slot in the play area. If any cards match in the play area, the player selects Match. All matched cards are moved to the match area (one slot for each unique card type). If more than one card exists in the match area, the player selects which card in the match area they would prefer. The card attribute score is incremented by 1 for each other card type in the match area. The match area is then cleared.

If no matches existed in the match area, the player selects which card in the play area they would least prefer. The card attribute score is decremented by 1 for the selected card type, and the card is removed from the play area.

After having made a selection in either the play area or the match area, the player's progress score is calculated. The progress score numerator is equal to the number of unique score values in the attribute score list. The progress score is the progress score numerator divided by the number of card attributes. For example, if there are 10 card types and five unique scores, the player has a 50% progress score.

The updated progress score is displayed on the game screen. If the progress bar is less than 100% and there are not enough cards in the draw pile to fill the play area, the deck is re-shuffled. If the progress bar is less than 100%, play returns to the point where the player clicks on the draw pile. The game announces the game is over to the player.

Next, the game builds a response dataset array that contains the unique respondent ID, as collected from the data collection platform, the Gamelnstance identifier, the Project identifier, the Gamelnstance authentication token, and an array of score values, with one element for the finals core of each card attribute score, in the same order as the attributes are listed in the game configuration.

The game submits the response dataset to the game service. The game service authenticates that the Gamelnstance, Project, and authentication tokens match. If the game service successfully authenticates the response, it creates a new response record that stores a date and timestamp, the GameInstance identifier, the Respondent identifier, and the Response dataset in the response database 36.

The service increments the completed response count for the GameInstance. The service increments the completed response count for the Client account. The survey proceeds to the next question in the survey. This loop repeats for any additional games configured in the survey.

Referring to FIGS. 1, 2 and 7, further details of the analysis and reporting process 20 are illustrated. The client may analyze and export the results of a project at any time, either while it is live or after it has completed 200. The client first logs into the system using their existing account information 202 and requests an analysis report from a list of available projects for analysis displayed 204. Game configuration settings from the GameInstance configuration database 32 are retrieved 206, as well as analysis rules from the games database 30 for each GameInstance in the project 208. Each game in the Games Database includes information that describes how the behavioral data stored in the user responses should be transformed for analysis and reporting purposes. Some games may only require simple algebraic formulae to interpret the results; others may use custom code to process each response record. All of the response data for a specific GameInstance are retrieved 210 from the Response Database 36.

One or more rule engines are used to interpret each of the response records and generate one or more “scores” (behavioral outcomes) for each player that completed the game 212. The player-specific scores are stored in the Reports database 36 including the transformed response set 214. The client then selects a desired output format for the Report 216, such as an Excel file or SPSS file. The system exports the data from the Reports database 36 in the desired output format 218. Each row in the dataset may represent the outcome(s) of a single survey participant; each column may indicate the transformed score. The unique survey respondent identifier may also be included for each row, to allow for the data to be easily merged with non-game data from the rest of the survey.

At any point during or after a project has begun collecting data, the client may review the data by selecting “Analysis & Reporting” from the project management screen. The client selects one or more games from the project configuration that should be reviewed. The client may view game results online, or export the data to a file for download.

The client selects “View Data” from the Analysis & Reporting screen to view a report. For each selected game, the service calls the Report ( ) function for that game type. The following description details reporting characteristics for the MaxDiff card game; reporting attributes and formatting will vary for each game. The service calculates the total score for each attribute in the game. The service uses the total score to calculate an average score for each attribute. The range of scores is determined (maximum score minus minimum score). The attribute list is displayed, with the average score next to it and a horizontal bar that is scaled to the range of average scores.

To download the results, the client selects “Download Export” from the Analysis & Reporting screen. A blank Excel file is created in memory. For each selected game for export, two worksheet tabs are added to the in-memory Excel file, a Summary tab, labeled with the name of the game, which contains the summary data described in the Report and a Raw Data tab. The Raw Data tab may organize the information into columns such as Respondent ID and Date/Timestamp of the response, for example. The Raw Data tab may include rows such as one row for each Response record for the GameInstance being exported.

Table of Contents worksheet may be added to the front of the in-memory Excel file containing such information as a description of the file, a report creation date, and links and descriptions to each of the other worksheets in the file.

The in-memory Excel file is returned to the client's browser as a downloadable file.

When a project has completed, the client closes the project from the project management screen. The project status is changed to Closed to prevent the game from being inadvertently displayed, since it will no longer pass authentication tests.

The client is redirected to the Analysis & Reporting page.

It is to be understood that while certain now preferred forms of this invention have been illustrated and described, it is not limited thereto except insofar as such limitations are included in the following claims.

Having thus described the invention, what is claimed as new and desired to be secured by Letters Patent is:

1. A survey gaming method comprising:
creating a user account;
creating a research project;
configuring one or more research games;
publishing said research game;
measuring and recording interactions with said research game;
analyzing said interactions;
reporting said interactions.

2. A survey gaming method comprising:
creating a new survey project;
linking said new survey project to at least one survey software platform;
selecting a game from a list of available research games;
defining custom configuration settings for said game to present a configured game;
publishing said configured game to said survey software platform.

3. The method of claim 2 further comprising:
retrieving survey software platform information from a software platform configuration database.

4. The method of claim 3 further comprising:
generating and storing a project configuration record in a project configuration database.

5. The method of claim 2 further comprising:
storing said custom configuration in a game instance configuration database.

6. The method of claim 2 wherein said defining step further comprises defining custom configuration settings for a plurality of games.

7. The method of claim 6 further comprising:
inserting a custom question for each said game in a software platform configuration database for launching said game.

8. A survey gaming method comprising:
retrieving a game from a games database for a survey;
retrieving a configuration associated with said game from a game instant configuration database;
launching said game using said configuration; and
capturing interactions with said game.

9. The method of claim 8 further comprising:
authenticating a user identifier of a survey respondent of said game.

10. The method of claim 7 wherein said captured interactions with said game are stored in response database.

11. The method of claim 10 further comprising determining game results and scores and storing said game results and scores in said response database upon termination of said game.

12. The method of claim 11 further comprising:
storing said scores in a game instance configuration database.

13. The method of claim 11 further comprising replaying said game.

14. The method of claim 11 further comprising submitting said user identifier and game results to a survey platform data warehouse.

15. The method of claim 11 further comprising:
determining the progress of said survey.

16. A survey gaming method comprising:
retrieving game configuration settings from a game instance configuration database for a project;
retrieving analysis rules from a games database for each game instance in said project;
retrieving response data for each game instance from a response database;
interpreting said response data and generating a score for a player that completed a game instance;
storing user-specific scores and associated transferred response set data in a reports database;
exporting said user-specific data from said reports database in a desired format.
